(19) United States
(12) Patent Application Publication
(10) Pub. No.: US 2015/0097936 A1
(43) Pub. Date: Apr. 9, 2015

(54) Non-Contact Fingerprinting Systems with Afocal Optical Systems

(71) Applicants: Steven J. Simske, Fort Collins, CO (US); Guy Adams, Stroud GLOS (GB)

(72) Inventors: Steven J. Simske, Fort Collins, CO (US); Guy Adams, Stroud GLOS (GB)

(21) Appl. No.: 14/364,732

(22) PCT Filed: Apr. 12, 2012
(86) PCT No.: PCT/US2012/033174

§ 371 Date: Jun. 12, 2014

(51) Int. Cl. G06K 9/00

(52) U.S. Cl. CPC G06K 9/00033
USPC 348/77

(57) ABSTRACT

An embodiment of a fingerprinting system may include a receiver configured to receive a finger and an image-capturing device optically coupled to the receiver and configured to capture an image of a fingerprint from a target region of the finger. The image-capturing device may include an afocal optical system. The fingerprinting system may configured so that the image-capturing device captures the image of the fingerprint from the target region without the target region of the finger being in direct physical contact with a solid surface.

### BACKGROUND

Fingerprints are widely accepted as unique identifiers for individuals. Fingerprinting can be used as a biometric to verify identities to control attendance, access, e.g., to restricted areas, electronic devices, etc. For example, conventional fingerprint detectors typically require a user to place a finger or hand on the detector. The fingerprint is detected by the detector and compared to a catalogued fingerprint for the user.

### BRIEF DESCRIPTION OF THE DRAWINGS

FIG. 1 illustrates a fingerprinting system, according to an embodiment.

FIG. 2 is a block diagram illustrating a fingerprinting system, according to another embodiment.

FIG. 3 illustrates an example of an afocal optical system of a fingerprinting system, according to another embodiment.

FIG. 4A illustrates a fingerprinting system, according to another embodiment.

FIG. 4B shows a front view of a frame of a fingerprinting system, according to another embodiment.

### DETAILED DESCRIPTION

In the following detailed description, reference is made to the accompanying drawings that form a part hereof, and in which is shown, by way of illustration, specific embodiments. In the drawings, like numerals describe substantially similar components throughout the several views. Other embodiments may be utilized and process, structural, logical, and electrical changes may be made without departing from the scope of the present disclosure. The following detailed description is, therefore, not to be taken in a limiting sense.

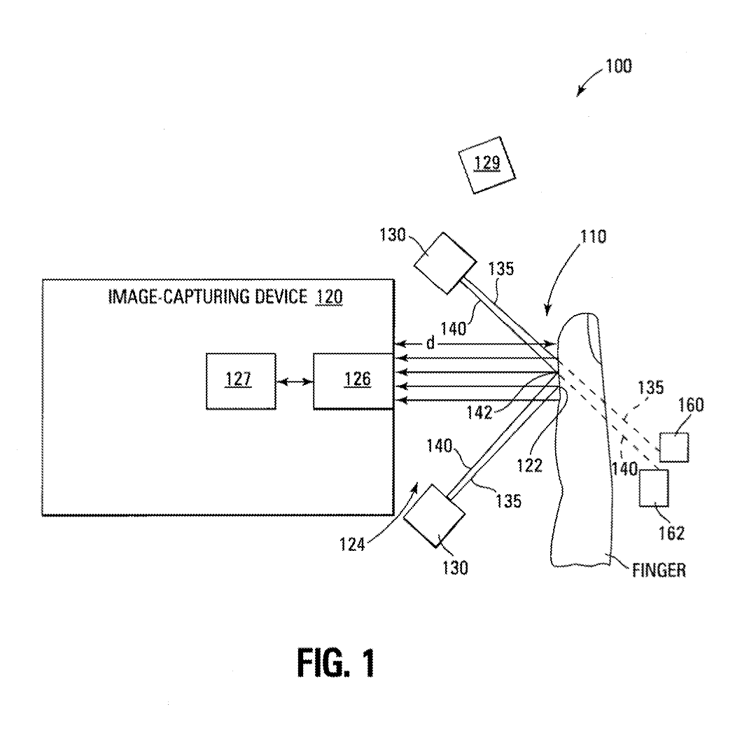

FIG. 1 illustrates a fingerprinting system 100, such as a biometric fingerprinting system, configured to capture a fingerprint. As used herein, the term fingerprint may refer to a pattern of ridges (e.g., sometimes called friction ridges or epidermal ridges) on a portion of a body, such as a human finger, toe, etc. Fingerprinting system 100 may be configured to verify an identity of a user using fingerprints. Fingerprinting system 100 may be part of a security system, e.g., of an electronic device, a building, etc.

Fingerprinting system 100 may include a receiver 110 configured to receive a finger and an image-capturing device 120 optically coupled to receiver 110. Fingerprinting system 100 may be configured so that image-capturing device 120 captures a fingerprint from a target region 122 of the finger without target region 122 being in direct physical contact with a solid surface. For example, receiver 110, and thus a finger received therein, may be separated from image-capturing device 120 by a gap 124, e.g., of air. For some embodiments, a fingerprint may be captured from target region 122 while the finger is in mid-air.

Target region 122 may include the fingerprint, e.g., such as friction ridges or epidermal ridges. Target region 122 may include other features (e.g., micro-features) in addition to the fingerprint, such as transient defects, e.g., including, cuts, inflammation, swollen pores, or other injuries, that may be tracked. For example, changes in the micro-features may be tracked for the users. For example, such tracking may be referred to as temporal identity mapping. Keeping track of changes in the micro-features in addition to the fingerprint may create a hard-to-copy biometric that can increase the statistical robustness of a fingerprinting process.

Requiring a finger to contact a solid surface during fingerprinting, as is common in conventional fingerprint detectors, can result in security, health, and equipment risk. An advantage of not having target region 122 touch a solid surface may be higher security since no fingerprint “residue” is left behind in an optical path from image-capturing device 120 to target region 122. For example, a portion previous user's fingerprint (e.g., known as fingerprint “residue”) may be left on the solid surface in the optical path between the finger and the fingerprint sensor in a conventional fingerprint detector.

Touching such a solid surface can also leave pathogens behind that can be transmitted to a finger of a subsequent user, presenting a health risk. An advantage of not having target region 122 touch such a solid surface reduces the risk of transmitting pathogens.

For some embodiments, image-capturing device 120 may include an optical system (e.g., one or more lenses and, for some embodiments, one or more mirrors), such as an afocal optical system 126 (e.g., that may be referred to as an afocal lens system or an afocal lens). Afocal optical system 126 may be optically coupled to a sensor 127. Afocal optical system 126 may receive an image of a fingerprint, in the form of electromagnetic radiation reflected from target region 122, and may transmit the image to sensor 127.

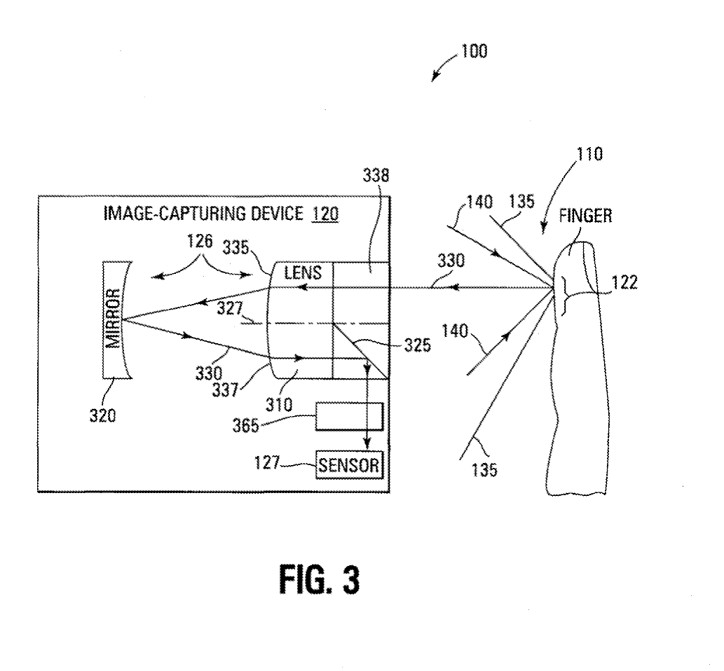

Afocal optical system 126 facilitates capturing a fingerprint from target region 122 when target region 122 is at a distance from afocal optical system 126, thus allowing the fingerprint to be captured without target region 122 contacting a solid surface, such as of afocal optical system 126. An example of afocal optical system 126 is discussed below in conjunction with FIG. 3.

In general, afocal optical systems may be effectively focused at infinity (e.g., may have an effectively infinite focal length), may have substantially no net convergence or divergence (e.g., may have no net convergence or divergence for some embodiments) in their light paths, and can operate at non-contact object distances. Some afocal optical systems may produce collimated electromagnetic radiation, such as light, at substantially unity magnification. The advantage of afocality is that a collimated, defined field of view can be at great relative distance, facilitating the non-contact between target region 122 and a solid surface.

For some embodiments, fingerprinting system 100 may include another image-capturing device, such as a camera 129, e.g., a video camera, that is directed at receiver 110 and thus a finger received in receiver 110. Camera 129 may be used for capturing (e.g., recording) various gestures of a user's finger(s) as the user's finger(s) is being received in receiver 110. Camera 129 enables gesture recognition that provides an additional level of security to fingerprinting system 100.

For some embodiments, fingerprinting system 100 may include one or more electromagnetic radiation (e.g., light) sources 130 that are configured to illuminate receiver 110, and thus a finger received in receiver 110, with beams 135 of electromagnetic radiation, such as infrared radiation, visible light, or ultraviolet radiation. As such, image-capturing device 130 may be configured to detect infrared, visible (e.g., light), and/or ultraviolet radiation. Hereinafter, the term light will be used cover all types of electromagnetic radiation, including infrared, visible, and ultraviolet radiation.

For some embodiments, light sources 130 may be configured to emit alignment beams 140 of visible light independently of beams 135. For example, alignment beams 140, and thus the sources thereof, may form at least a portion an alignment system of receiver 110 and thus fingerprinting system 100. Alternatively, beams 135 and beams 140 may be emitted from separate light sources. Beams 140 may be colored red for some embodiments.

Beams 140 may cross each other at a crossing point 142 that is aligned with afocal optical system 126 in image-capturing device 120. For example, positioning a finger so that crossing point 142 lands on a predetermined location of target region 122, e.g., the center of target region 122, may properly align target region 122 with afocal optical system 126. During operation, target region 122 reflects the light from beams 135 to afocal optical system 126.

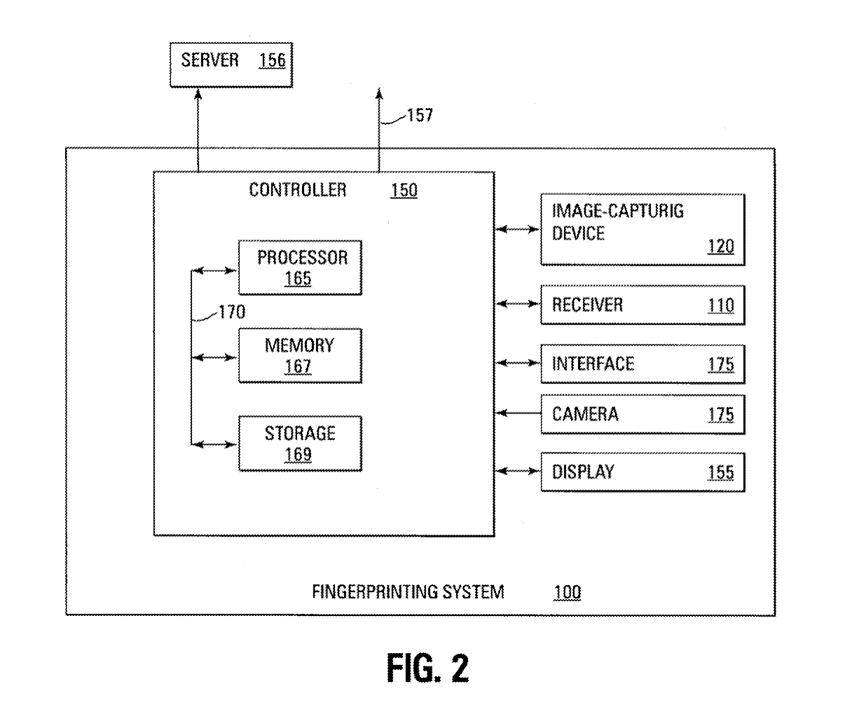

FIG. 2 is a block diagram of fingerprinting system 100, including blocks representing receiver 110, image-capturing device 120, and camera 129. Fingerprinting system 100 may include a controller 150 that may be coupled to receiver 110, image-capturing device 120, camera 129, and a display 155, such as an auditory and/or visual display.

Controller 150 may be configured to cause fingerprinting system 100 to perform the methods disclosed herein. For example, controller 150 may be configured to receive captured image data, e.g., a bitmap, representing a captured fingerprint from image-capturing device 120 and to compare the captured image data to stored image data, representing a stored fingerprint, stored in a database (e.g., a fingerprint database) within controller 150 or externally to controller 150, such as on a network server 156, e.g., in a local area network (LAN), wide area network (WAN), the Internet, etc. The captured image data representing a captured fingerprint may be referred to as captured fingerprint data (e.g., a captured fingerprint), and the stored image data representing a stored fingerprint may be referred to as stored fingerprint data (e.g., a stored fingerprint).

Controller 150 may be configured to authenticate a user (e.g., by verifying an identity of a user) in response to the user's captured fingerprint matching a stored fingerprint for that user. That is, in response to the captured image data representing the user's captured fingerprint matching the stored image data representing a stored fingerprint.

Controller 150 may be configured to verify a user's identity in response to the fingerprints captured from a plurality of the user's fingers matching a plurality of stored fingerprints. For some embodiments, controller 150 may be configured to require that the user present different fingers in a certain order in order to verify the user's identity. In other words, controller 150 may be configured to verify a user's identity in response to different fingerprints of the user in presented in a certain order matching stored fingerprints in a certain order.

Requiring matches of different fingerprints in a certain order can increase overall security and can reduce the chance for a false positive. As such, fingerprinting system 100 may be configured to authenticate (e.g., verify) a user based on fingerprints captured from target regions 122 of different fingers presented in a certain order.

For example, if the false positive rate is found to be an error probability of 2×10⁻⁴ for one finger, then two different fingers provide an error probability of 4×10⁻⁸. Requiring that the two different fingers be in a certain order reduces the probability, in that there are 56 combinations of choosing a first one of the 8 non-thumb fingers followed by different one of them. This reduces the overall probability of a false positive to (40/56)×10⁻⁹, which less than the 1 chance in the billion required for forensic identification. As such, fingerprinting system 100 may be configured to provide forensic-level security.

For some embodiments, controller 150 may be configured to stop the process of capturing fingerprints from target regions of different fingers presented in a certain order and to authenticate a user in response to the overall probability of a false positive reaching a certain level. For example, controller 150 may stop the process and authenticate a user in response to the fingerprints captured from the target regions of a certain number of fingers presented in the certain order matching (e.g., two different fingers presented in the certain order matching), e.g., when the overall probability of a false positive is less than the 1 chance in a billion.

Controller 150 may inform the user via a display 155 coupled thereto of the verified identity in response to controller 150 verifying the user's identity. Controller 150 may be configured to transmit a signal 157 in response to verifying the user's identity. For example, signal 157 may be transmitted to an electronic device that grants the user access to the electronic device in response to receiving signal 157. The signal 157 may cause a solenoid to unlock a door, etc. For some embodiments, signal 157 may be sent to security personnel, e.g., over a network to a computer, to inform the security personnel that the user's identity is verified.

For other embodiments, signal 157 may be set to a first logic level (e.g., logic high) in response to controller 150 verifying the user's identity, where the first logic level causes the electronic device to grant the user access thereto, causes the door to unlock, informs security personnel that the user's identity is confirmed, etc.

If a user's identity is not verified, e.g., the user's fingerprint(s) does not match any fingerprints in the fingerprint database and/or that user's fingers are presented in the wrong order, controller 150 may inform the user as such via display 155. The controller 150 may be configured not to transmit signal 157 in response to user's identity not being verified. For other embodiments, signal 157 may be set to a second logic level (e.g., logic low) in response to controller 150 not being able to verify the user's identity, where the second logic level prevents the electronic device from granting the user access thereto, prevents the door from unlocking, informs security personnel that the user's identity is not confirmed, etc. As such signal 157 may be indicative of the user's identity, e.g., indicative of whether the user's identity is verified.

In addition to receiving fingerprint data from image-capturing device 120, controller 150 may be configured to receive video data from camera 129 that represents the movement of the user's finger(s) as the user's finger(s) are received in receiver 110. Controller 150 may be configured to compare video data from camera 129 to stored pre-recorded video data that may be stored in a database (e.g., a video database) within controller 150 or externally to controller 150, such as on network server 156.

For example, controller 150 may be configured to compare gestures of a finger captured by camera 129 to gestures of fingers stored in the database. If the gestures captured by camera 129 match gestures stored in the database, the user's identity is further verified when the user's identity is verified through fingerprinting. Controller 150 may cause display 155 to display an error message that requires the user to reenter its fingerprint(s) and/or may send a message to security personnel, indicating a potential security alert, in response gestures of a finger captured by camera 129 mismatching gestures of fingers stored in the database. For some embodiments, controller 150 may be configured to stop the process of capturing and comparing gestures and to indicate a gesture match in response to the overall probability of a false positive reaching a certain level, e.g., when the overall probability of a false positive is less than the 1 chance in a billion. For example, controller 150 may be configured to indicate a gesture match in response to a certain number of gestures in a certain order matching.

Controller 150 may be configured to receive an indication from receiver 110, indicating whether a finger has been received by receiver 110. In response to receiving an indication that a finger has been received by receiver 110, controller 150 may cause image-capturing device 120 to capture an image of a fingerprint from target region 122 of the finger.

Controller 150 may be configured to determine whether target region 122 is in focus and/or whether target region 122 is properly aligned with afocal optical system 126 before causing image-capturing device to capture the fingerprint. Controller 150 may be configured to determine whether target region 122 is in focus and/or whether target region 122 is properly aligned with afocal optical system 126 in response to receiving an indication that a finger has been received by receiver 110. For example, controller 150 may receive a signal having first logic level (e.g., logic high) from receiver 110 in response to a finger being received by receiver 110. When no finger is in receiver 110, controller 150 may receive a signal having a second logic level (e.g., logic low) from receiver 110. Note that when one or more operations are performed in response to an event, such as receiving a signal, without user intervention, the one or more operations may be taken as being performed automatically for some embodiments.

One of beams 135 may be received by a sensor 160, coupled to controller 150, when no finger is in receiver 110, as indicated by a dashed line in FIG. 1, and sensor 160 may send the signal with the second logic level to controller 150. However, when a finger is in receiver 110, the finger prevents beam 135 from being received by sensor 160, and sensor 160 may send the signal with the first logic level to controller 150. For some embodiments, each of beams 135 may be received by a respective sensor 160 coupled to controller 150.

Alternatively, one of beams 140 may be received by a sensor 162, coupled to controller 150, when no finger is in receiver 110, as indicated by a dashed line in FIG. 1, and sensor 162 may send the signal with the second logic level to controller 150. However, when a finger is in receiver 110, the finger prevents beam 140 from being received by sensor 162, and sensor 162 may send the signal with the first logic level to controller 150. For some embodiments, each of beams 140 may be received by a respective sensor 162 coupled to controller 150.

For some embodiments, controller 150 may be configured to perform a feedback alignment method, e.g., in response to determining that target region 122 is not properly aligned with afocal optical system 126, that properly aligns target region 122 with afocal optical system 126 (FIG. 1). Proper alignment of target region 122 with afocal optical system 126 might be an alignment that allows predetermined portions of target region 122, such as predetermined regions of a fingerprint to be captured by image capturing device 120.

For example, the predetermined portions might facilitate a comparison with like portions of a stored fingerprint, thereby allowing controller 150 to determine whether a user's fingerprint matches a fingerprint in the fingerprint database, thus allowing controller 150 to verify the user's identity. Therefore, the controller 150 might determine that a target region 122 is not properly aligned in response to determining that a captured image of target region 122 does not include the predetermined portions.

If controller 150 determines that target region 122 is not properly aligned, controller 150 may inform the user, e.g., via display 155, that its finger is not properly aligned and may instruct the user to reposition its finger. Controller 150 may then cause image-capturing device 120 to capture another image of target region 122 in response to the user repositioning its finger, and controller 150 may determine whether the target region 122 is now properly aligned. If the target region 122 is properly aligned, controller 150 will cause display 155 to inform the user as such. If controller 150 determines that target region 122 is still not properly aligned, controller 150 may inform the user that its finger is not properly aligned and may instruct the user to reposition its finger again. The feedback alignment method may be repeated until controller 150 determines that target region 122 is properly aligned with afocal optical system 126. For example, the feedback alignment method may be an iterative process for some embodiments.

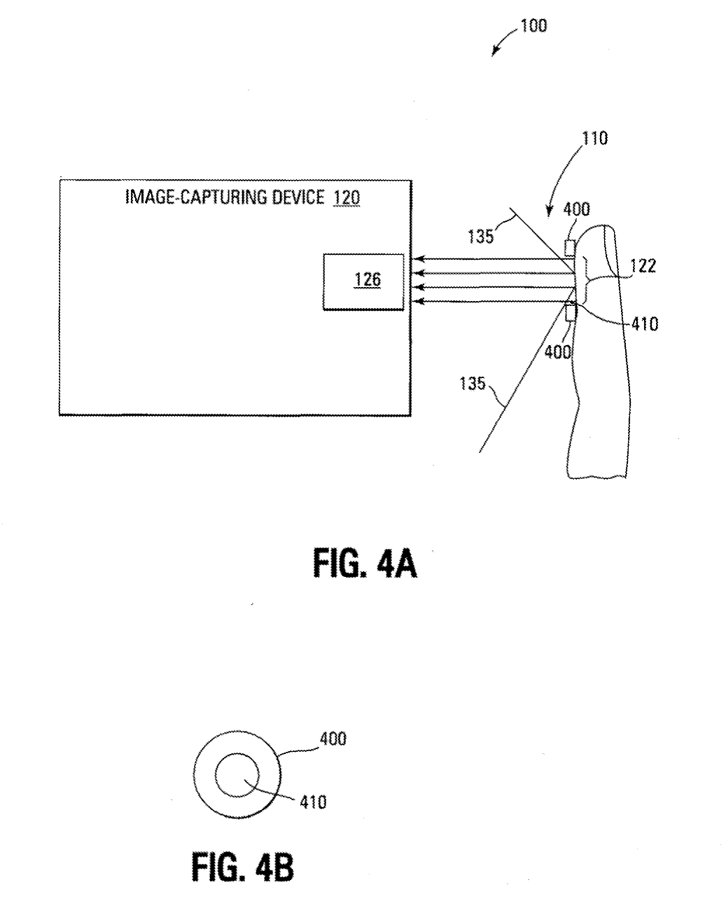

For some embodiments, the feedback alignment method may be used in conjunction with positioning the finger so that crossing point 142 lands on a predetermined point of target region 122. For other embodiments, the feedback alignment method may be used in conjunction with a frame (e.g., discussed below in conjunction with FIGS. 4A and 4B) configured to align target region 122 with afocal optical system 126.

Note that positioning a finger so that crossing point 142 lands on a predetermined location of target region 122, as discussed above in conjunction with FIG. 1, may be sufficient by itself to properly align target region 122 with afocal optical system 126. For some embodiments, a sign may be placed on fingerprinting system 100 to indicate the location on a finger corresponding to target region 122 and to indicate the predetermined location in target region 122 for the crossing point 142 for proper alignment. Alternatively, controller 150 may cause display 155 to indicate the location on a finger corresponding to target region 122 and to indicate the predetermined location in target region 122 for the crossing point 142 for proper alignment.

For some embodiments, controller 150 may be configured to perform a focusing method, e.g., in response to determining that target region 122 is not in focus, to bring target region 122 into focus. Adjusting a distance d (FIG. 1) from afocal optical system 126 to target region 122, e.g., by moving afocal optical system 126 and/or target region 122 may accomplish this.

For example, controller 150 may move afocal optical system 126 until it determines that target region 122 is in focus. Alternatively, controller 150 may instruct a user, e.g., via display 155, to move its finger closer to or further away from afocal optical system 126 until it determines that target region 122 is in focus. For example, controller 150 may cause image-capturing device 120 to capture an image of at least a portion target region 122 and to determine whether the at least the portion target region 122 is in focus at each position of the afocal optical system 126 and/or the user's finger.

Controller 150 may include a processor 165 for processing for processing machine-readable instructions, such as processor-readable (e.g., computer-readable) instructions. These machine-readable instructions may be stored in a memory 167, such as a non-transitory computer-usable medium, and may be in the form of software, firmware, hardware, or a combination thereof. The machine-readable instructions may configure processor 165 to allow controller 150 to cause fingerprinting system 100 to perform the methods and functions disclosed herein. In other words, the machine-readable instructions configure controller 150 to cause fingerprinting system 100 to perform the methods and functions disclosed herein.

In a hardware solution, the machine-readable instructions may be hard coded as part of processor 165, e.g., an application-specific integrated circuit (ASIC) chip. In a software or firmware solution, the instructions may be stored for retrieval by the processor 165. Some additional examples of non-transitory computer-usable media may include static or dynamic random access memory (SRAM or DRAM), read-only memory (ROM), electrically erasable programmable ROM (EEPROM or flash memory), magnetic media and optical media, whether permanent or removable. Some consumer-oriented computer applications are software solutions provided to the user in the form of downloads, e.g., from the Internet, or removable computer-usable non-transitory media, such as a compact disc read-only memory (CD-ROM) or digital video disc (DVD).

Controller 150 may include storage device 169, such as a hard drive, removable flash memory, etc. Storage device 169 may be configured to store the fingerprint database that contains the fingerprints that are compared to the captured fingerprints. Storage device 169 may be further configured to store the video database that contains the video data that are compared to the video data captured by camera 129. Processor 165 may be coupled to memory 167 and storage 169 over a bus 170.

A human-machine interface 175 may be coupled to controller 150. Interface 175 may be configured to interface with a number of input devices, such as a keyboard and/or pointing device, including, for example, a mouse. Interface 175 may be configured to interface with display 155 that may include a touchscreen that may function as an input device.

For some embodiments, a user may initiate the operation of fingerprinting system 100 via interface 175. That is, fingerprinting system 100 may perform at least some of the methods and functions, such as capturing fingerprints, disclosed herein in response to user inputs to interface 175.

Fingerprinting system 100 may instruct the user, via display 155, to position a finger in receiver 110, may capture a fingerprint from the finger, and may compare the fingerprint to a fingerprint in the fingerprint database. Fingerprinting system 100 may also capture the user's gestures using camera 129 and compare them to pre-recorded gestures in the video database.

Fingerprinting system 100 may also instruct the user to insert different fingers into receiver 110 in a certain order, for embodiments where fingerprinting system 100 is configured to detect fingerprints from different fingers in a certain order, may capture fingerprints from those fingers, and may compare those fingerprints in the fingerprint database. For example, the fingerprint database might store different fingerprints in a certain order for each of a plurality of persons.

Controller 150 may compare a first captured fingerprint captured from a first finger of a user to the first stored fingerprint for each person in the database. Then, in response to a match of the first fingerprints, controller 150 might instruct the user to insert a second finger different than the first into receiver 110 and cause image-capturing device 120 to capture a second fingerprint from the second finger. Controller 150 may then compare the second captured fingerprint of the user to the second stored fingerprint of the person in the database whose first fingerprint matched the first captured fingerprint of the user. Controller 150 may then verify the user's identity to be the person in the database whose first and second fingerprints respectively match the first and second captured fingerprints of the user. This may be repeated for any number of different fingers, e.g., up to eight for some embodiments or up to ten, including thumbs, for other embodiments.

For some embodiments, the afocal system 126 (FIGS. 1 and 2) may be configured to capture the micro-features, such as transient defects. For example. afocal system 126 may be zoomed to capture images of the other features. Controller 150 may be configured to detect and keep track of the micro-features. For other embodiments, the captured images of target region 122 may have plurality of different resolutions, as discussed below in conjunction with FIG. 3. For example, the ridges of the fingerprint may be observable (e.g., detectable by controller 150) at lower resolutions, while the micro-features and better definition of the ridges may be observable at higher resolutions.

Controller 150 may detect the micro-features in target region 122 in addition to the fingerprint from captured images of target region 122 and may store these captured images of target region 122, e.g., in memory device 169 or network server 156. Controller 150 may be configured to compare the micro-features detected from subsequent images to the micro-features in the stored images.

For some embodiments, controller 150 may be configured to obtain a baseline image of target region 122, e.g., including a fingerprint and any micro-features. Controller 150 may then might keep a rolling log, e.g., in storage 169, of changes to the baseline image, such as changes in the micro-features in baseline image. For example, controller 150 might update stored image data of target region 122 each time an image is captured of target region 122.

FIG. 3 illustrates an example of afocal optical system 126 of image-capturing device 120, e.g., configured as a afocal relay optical system. Common numbering is used in FIGS. 1 and 3 to denote similar (e.g., the same) components, e.g., as described above in conjunction with FIG. 1.

Afocal optical system 126 may include a lens 310 (e.g., a refractive lens) optically coupled to a mirror 320 (e.g., a concave mirror). A turning mirror 325 may be on an opposite side of lens 310 from mirror 320. Lens 310 may be symmetrical about a symmetry axis 327 that passes through a center of lens 310 so that portions 335 and 337 on opposite sides of symmetry axis 327 in the cross-section of lens 310 shown in FIG. 3 are symmetrical.

For some embodiments, portion 335 of lens 310 may receive light 330 that is reflected from target region 122 of a finger. Light 330 may be refracted as it passes through a curved surface of portion 335 while exiting portion 335. The refracted light 330 is subsequently received at mirror 320. Mirror 320 may reflect light 330 onto a curved surface of portion 337 of lens 310.

Light 330 may be refracted as it passes through the curved surface of portion 337 so that the light passing through portion 337 is symmetrical with the light 330 passing in the opposite direction through portion 335. Passing light through portion 336 of lens 310 and back through portion 337 of lens 310 can result in substantially no net magnification (e.g., no net magnification for some embodiments) of target region 122, e.g., a property of some afocal systems. Note that the curved surfaces of portions 335 and 337 may be contiguous, thus forming a continuous curved surface of lens 310 for some embodiments.

An extension 338 of lens 310 may be aligned with target region 122. For example, extension 338 may be aligned with target region 122 as discussed above in conjunction with FIGS. 1 and 2. Extension 338 may be referred to as an optical opening (e.g., an optical port) that permits transmission of at least a portion of one or more wavelengths of light. Extension 338 may receive light 330 reflected from target region 122 and may direct light 330 to the portion 335 of lens 310.

After exiting portion 335 of lens 310, and thus afocal system 126, light 330 may be received at turning mirror 325 that maybe separate from or integral with (as shown in FIG. 3) lens 310. In other words, afocal system 126 may direct light 330 onto turning mirror 325. Turning mirror 325 turns light 330, e.g., by substantially 90 degrees, and reflects light 330 onto sensor 127 of image-capturing device 120. For some embodiments, a lens 365 may be between turning mirror 325 and sensor 127.

For example, sensor 127 may be smaller than the image of target region 122, and lens 366 may be configured to reduce the size of the image of target region 122 to the size of sensor 127. Alternatively, sensor 127 may be larger than the image of target region 122, and lens 365 may be configured to increase the size of the image of target region 122 to the size of sensor 127.

Sensor 127 may include a two-dimensional array sensing elements, such as charge coupled device (CCD) sensing elements or CMOS, configured to sense light. For example, each sensing element may correspond to a pixel of the captured image of a target region 122. For some embodiments, sensor 127 may include up to or more than 8000 sensing elements per centimeter in each of the two dimensions, providing a resolution of up to or more than 8000 pixels/cm (e.g., up to or more than 8000 lines of resolution).

For some embodiments, controller 150 may be configured to cause image-capturing device to capture a plurality of resolutions, e.g., different resolutions. For example, a high resolution, such as 8000 lines, may be captured as well as lower resolutions, such as 4000 lines, 2000 lines, etc.

The lower resolutions may be obtained through pixel binning on the sensor or down-sampling or resampling with intentionally lower resolutions. For example, a higher-resolution image may be obtained and lower resolutions may be obtained therefrom by averaging over fewer numbers of pixels of the higher-resolution image. For some embodiments, higher resolutions enable the capture of the micro-features in target region 122. The higher resolutions may also provide higher ridge definition.

For other embodiments, image-capturing device 120 may include an afocal system similar to those used in afocal photography. For example, image-capturing device 120 may include an afocal system (e.g., a telescope/finderscope) optically coupled to (e.g., positioned in front of) a camera, such as a digital camera, and may be directed at target region 122. In such embodiments, the power/magnification of the telescope/finderscope is used to increase the operating/object distance.

FIG. 4A illustrates an embodiment of fingerprinting system 100 that includes a receiver 110 having a frame 400 configured to align target region 122 of a finger with afocal optical system 126. Frame 400 may form at least a portion an alignment system of receiver 110. FIG. 4A shows a side view of frame 400, while FIG. 48 shows a front view of frame 400. Common numbering is used in FIGS. 1 and 4A to denote similar (e.g., the same) elements, e.g., as described above in conjunction with FIG. 1.

A finger is received against frame 400 such that target region 122 is aligned with an opening 410 in frame 400. Opening 410 may be pre-aligned with afocal optical system 126 of image-capturing device 120, e.g., with extension 338. Note that when a finger is placed against frame 400, target region 122 is exposed by opening 410 and is not in direct physical contact with any solid surface. Although frame 400 is shown to have a circular shape, frame 400 may have a square or rectangular shape or any other polygonal shape.

For some embodiments, a sign may be placed on fingerprinting system 100 to indicate how a finger is to be placed against frame 400 so that target region 122 is exposed and is properly aligned with afocal optical system 126. Alternatively, controller 150 may cause display 155 to indicate how a finger is to be placed against platform 400 so that target region 122 is exposed and is properly aligned with afocal optical system 126.

During operation, light beams 135 pass through opening 410 and illuminate target region 122. Target region 122 may then reflect the light from beams 135 through opening 410 and into image-capturing device 120 through afocal optical system 126.

For some embodiments, frame 400 may be configured to move to bring target region 122 into focus. For example, controller 150 may determine whether target region 122 is in focus, as discussed above in conjunction with FIG. 1. If target region 122 is not in focus, the controller 150 may cause frame 400 and/or afocal lens 126 to move to until controller 150 determines that target region 122 is in focus.

Although specific embodiments have been illustrated and described herein it is manifestly intended that the scope of the claimed subject matter be limited only by the following claims and equivalents thereof.

What is claimed is:

1. A fingerprinting system, comprising:
a receiver configured to receive a finger; and
an image-capturing device optically coupled to the receiver and configured to capture an image of a fingerprint from a target region of the finger;
wherein the image-capturing device comprises an afocal optical system; and
wherein the fingerprinting system is configured so that the image-capturing device captures the image of the fingerprint from the target region without the target region of the finger being in direct physical contact with a solid surface.

2. The fingerprinting system of claim 1, wherein the fingerprinting system is configured to cause the image-capturing device to capture fingerprints from target regions of different fingers presented in a certain order and to compare the fingerprints captured from the target regions of different fingers presented in the certain order to different fingerprints in a certain order in a database.

3. The fingerprinting system of claim 1, wherein the afocal optical system comprises a afocal relay optical system.

4. The fingerprinting system of claim , wherein the afocal relay optical system comprises.
a lens; and
a mirror optically coupled to the lens and configured to receive light from a first curved surface of the lens and to reflect the light received from the first curved surface of the lens to a second curved surface of the lens.

5. The fingerprinting system of claim 4, wherein the first and second curved surfaces are contiguous.

6. The fingerprinting system of claim 1, further comprising another image capturing device configured to capture gestures of the finger as the finger is being received in the receiver, wherein the image capturing device is configured to compare the gestures captured by the another image capturing device to gestures stored in a database.

7. The fingerprinting system of claim 1, wherein the image-capturing device is configured to capture other features in the target region and to keep track of changes in the other features.

8. A method of operating a fingerprinting system, comprising:
capturing an image of a fingerprint from a target region of a finger using an image-capturing device without the target region of the finger being in direct physical contact with a solid surface;
wherein the image-capturing device comprises an afocal optical system.

9. The method of claim 8, further comprising capturing fingerprints from target regions of different fingers presented in a certain order using the image-capturing device and comparing with a controller the fingerprints captured from the target regions of different fingers presented in the certain order to different fingerprints in a certain order in a database.

10. The method of claim 8, further comprising capturing gestures of the finger using another image-capturing device and comparing with a controller the captured gestures to gestures stored in a database.

11. The method of claim 8, further comprising capturing other features in the target region of the finger using the image capturing device and keeping track of changes in other features with a controller.

12. The method of claim 8, wherein capturing the image of the fingerprint from the target region of the finger using the image-capturing device comprises:
receiving light reflected from the target region at a lens of the afocal optical system;
refracting the light at a first curved surface of the lens onto a mirror of the afocal optical system;
reflecting the light onto a second curved surface of the lens from the mirror and refracting the light at the second curved surface of the lens; and
directing the light refracted at the second curved surface to a sensor.

13. A non-transitory computer-usable medium containing machine-readable instructions that configure a processor to cause a fingerprinting system to perform a method, comprising:
capturing a fingerprint from a target region of a finger using an image-capturing device without the target region of the finger being in direct physical contact with a solid surface;
wherein the image-capturing device comprises an afocal optical system.

14. The non-transitory computer-usable medium of claim 13, wherein the method further comprises capturing fingerprints from target regions of different fingers presented in a certain order using the image-capturing device and comparing with a controller the fingerprints captured from the target regions of different fingers presented in the certain order to different fingerprints in a certain order in a database.

15. The non-transitory computer-usable medium of claim 13, wherein the method further comprises capturing gestures of the finger using another image-capturing device and comparing with a controller the captured gestures to gestures stored in a database.
